(19) United States
(12) Patent Application Publication
(10) Pub. No.: US 2012/0102753 A1
(43) Pub. Date: May 3, 2012

(54) Inside pipe cutter

(76) Inventor: Michael B. Cosentino, Brick, NJ (US)

(21) Appl. No.: 12/925,872

(22) Filed: Nov. 1, 2010

(51) Int. Cl. B23D 21/14

(52) U.S. Cl. 30/103

(57) ABSTRACT

A cutting tool principally used as an inside pipe cutter for plastic pipe which consists of a threaded round rod with the top end connected to a rotating drill and the bottom end connected to a rotating saw blade. The center portion of the rod is loosely enclosed within a sleeve which the operator holds to position the inside pipe cutter within the top of an open pipe to be cut by the rotating saw blade. The cutting tool may also be used as an outside pipe cutter.

### FIELD OF THE INVENTION

The present invention relates to the cutting of plastic piping which is commonly used in residential, commercial and industrial construction. The inside cutting tool of the present invention is useful to precisely and smoothly cut such piping so that it can be assembled and joined together with other piping and fittings.

### BACKGROUND AND SUMMARY OF THE INVENTION

Plastic piping, such as PVC, ABS, and CPVC, is now generally used for piping utilities Plastic has supplanted ceramic, cast iron and other metals in general piping applications. Plastic pipe must be cut to a certain length to be removed or replaced when removing or. repairing piping installations, This has required the development of new cutting methods. Former use of hacksaws and prior art outside cutters have proved onerous and .imprecise. In many cases a regular saw would not be useful without opening up a wall, floor or ceiling behind which a broken pipe is frequently located.

It is an object of the present invention to provide an improved inside cutting tool for use as a simple and precise cutting method for plastic and composition pipe.

This and other objects and advantages of the present invention will become apparent to those skilled in the art from the following drawings and detailed description.

### BRIEF DESCRIPTION OF THE SEVERAL VIEWS OF THE DRAWINGS.

FIG. 1 is a side view of the inside pipe cutter of the present invention;

FIG, 2 is a top view of the inside pipe cutter of FIG. 1;

FIG. 3 is a bottom view of the inside pipe cutter of FIG. 1; and

FIG. 4 is a sectional view of the inside pipe cutter along the axis line 4-4′ of FIG. 1.

### DETAILED DESCRIPTION

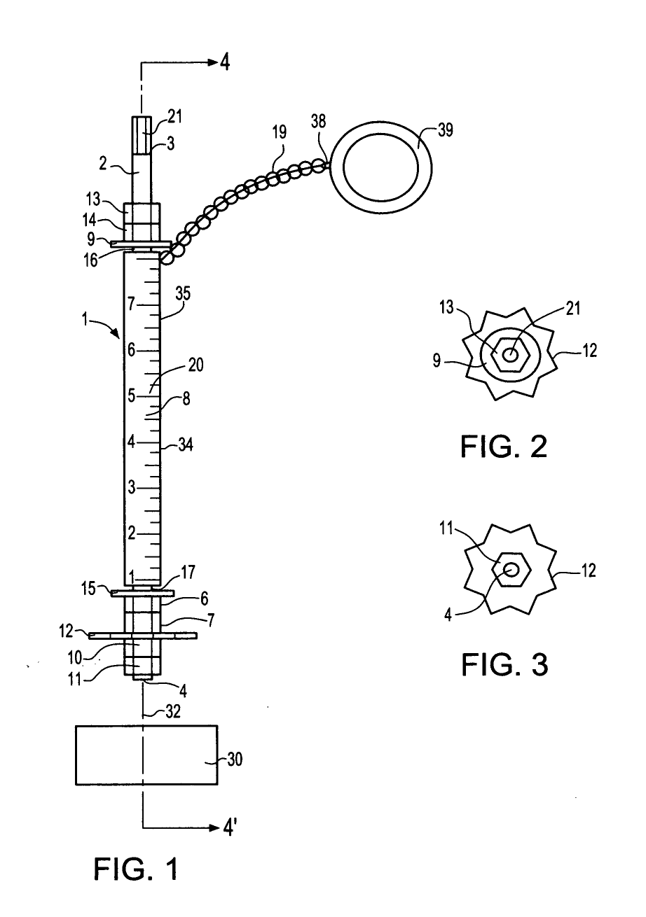

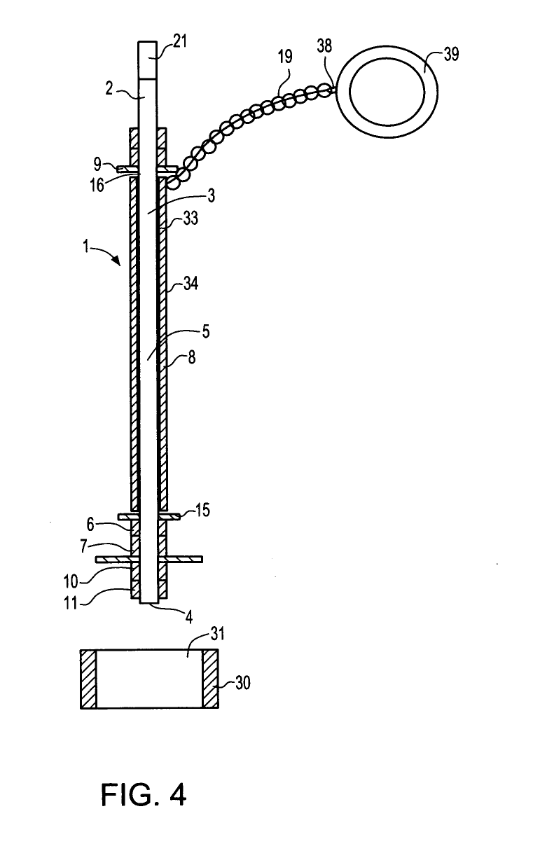

Referring now to the above drawings by numerals of reference, there is shown in FIGS. 1, 2 3 and 4 a disclosure of the inside pipe cutter of the present invention, generally shown as 1. which has a cylindrical, threaded rod 2, with a top end 3 held within a rotating drill chuck held by the operator (not shown) and a bottom end 4 above the open end 31 of the pipe 30 to be cut. The top end 3 of the rod 2 has the form of a hexagon 21 so as to be more securely held within a drill chuck. The top end 3 may have other polygonal forms or annular grooves to further secure the top end 3 to the drill chuck. The bottom end 4 of the threaded rod 2 is fastened perpendicularly to its concentric axis 32 with the rod 2 to a circular saw blade 12 by two pairs of threaded locking nuts 6, 7 and 10, 11 which are threaded and tightened on each side of the saw blade 12 in order to lock the inserted saw blade 12 to the rod 2 when the saw blade 12 is rotated by the drill during inside cutting of the pipe 30 within the open end 31 of the pipe 30.

A hollow cylindrical sleeve 8 has its inside surface 33 longitudinally and loosely enclosing the center portion 5 of the rod 2. The sleeve 8 is positioned over the central portion 5 of the rod 2 by a pair of threaded positioning nuts 13,14 at the top end of the rod 2 below the hexagonal end 21, and by the pair of threaded locking nuts 6,7 locking the circular saw blade 12. A top washer 9 is positioned on the rod 2 below the threaded positioning nut 14. A bottom washer 15 is positioned on the rod 2 above the threaded locking nut 6 in order to assure that the sleeve is loosely held longitudinally on the rod 2. Additional longitudinal spaces 16, 17, of about 1/16″, below the top washer 9 and above the bottom washer 15, respectively, are provided by the operator loosely holding the sleeve 8 longitudinally above the rod 2 while using the inside cutting tool 1.

After assembly of the above elements of the inside cutting tool 1, the operator may lubricate the center portion 5 of the rod 2, the inside of the sleeve 8, and the washers 9,15, which allows the rod 2 to freely and smoothly rotate within the sleeve 8 which is firmly held by a hand of the operator.so that saw blade 12 is steadily held within the open pipe top 31 of the pipe 30 to make a smooth and efficient cut of the pipe 30. The sleeve 8 may alternatively be made of plastic.

Another feature of the sleeve 8 is to have measurement calibrations 20 marked longitudinally on the outside sleeve surface 34. The calibrations 20 enable the operator to place the blade 12 of the inside pipe cutter 1 at a precise position below the open end 31 of the pipe 30 so that the precisely cut pipe 30 can be joined exactly with another pipe or pipe fitting,

A further feature of the inside pipe cutter 1 of the present invention 1 is to have a short metal, plastic or fiber chain 19 attached to the outside surface 34 above the top of the sleeve 8. The other end 37 of the chain 19 is attached to the outside periphery 38 of a metal loop or ring 39. The operator places his thumb or wrist within the loop 39 while he is holding the inside pipe cutter 1 with his hand to cut the pipe 30. Should the hexagonal end 21 of the inside pipe cutter 1 be inadvertently detached from the rotating drill chuck so that the inside pipe cutter 1 falls within the open pipe 30 then the operator can easily use the loop 39 and attached chain 19 as a leash to retrieve the inside pipe cutter 1 for reattachment of the hexagonal end 21 to the drill chuck and to continue cutting operation.

The inside pipe cutter 1 and the saw blade 12 may be made in different sizes to suit the sizes of the piping application.

### METHOD OF OPERATION

The method of operation of the inside pipe cutter 1 of the present invention is as follows:
1 After assembly of the various elements of the inside pipe cutter 1 as disclosed hereinabove; the elements may be lubricated to prevent binding during rotation;
2. The operator inserts the hexagonal end of the inside pipe cutter 1 within the chuck of a rotating drill;
3. The operator places his thumb or wrist within the loop 39 and firmly holds the sleeve 8 with his hand;
4. The operator places the bottom end 4 and the circular saw blade 12 of the inside pipe cutter 1 within the open end 31 of the pipe 30 to be cut at a predetermined measured position according to the calibrations 20 on the sleeve.19;
5; The operator turns on the rotating drill and steers the sleeve 8 within the open end 31 of the pipe 30 so that the saw blade 12 moves within the pipe 30 during rotation of the saw blade and cuts off the predetermined portion of the pipe 30; and
6. Alternatively, the pipe cutter can also be used as an outside cutter of the pipe 30.

The present invention has been defined by the disclosure hereinabove, but it should be understood that this is by way of illustration only and that the present invention is not necessarily limited thereto. Modifications and variations will be apparent from the disclosure without departing from the present invention as those skilled in the art will readily understand. Accordingly, such modifications and variations of the disclosed present invention are considered to be within the purview and scope of the present invention and the following claims:

We claim:

1. An inside pipe cutter for use in cutting plastic and composition pipe perpendicular to the axis of the pipe comprising:
a threaded round metal rod with the top end adapted for enclosure within a rotating drill chuck;
a circular saw blade connected perpendicularly to the axis of the rod at the bottom of the rod; and
a hollow cylindrical sleeve coaxial with and loosely enclosing the outside circumference of the center portion of the rod; whereby when the operator inserts the inside pipe cutter within the top of said pipe, and steadily holds the sleeve, the rotating saw cuts off a predetermined portion of the pipe at the top of said pipe.

2. The inside pipe cutter of claim 1 which additionally comprises measurement calibrations marked longitudinally on the outside surface of the center portion of the rod to indicate to the operator the interior depth of the circular saw when it is placed within the open end at the top of the pipe being cut.

3. The inside pipe cutter of claim 1 which additionally comprises a metal chain with one end attached to the outside top end of the sleeve and the other end attached to a metal loop through which the operator inserts his wrist or thumb, so that the chain and the loop comprise a leash for the operator to retrieve the inside cutting tool from within the pipe if the cutting tool loosens and falls from the chuck and into the pipe.

4. The inside cutting tool of claim 1 wherein the chain is made of plastic or fiber.

5. The inside cutting tool of claim 1 wherein the loop is made of plastic or fiber

6. The inside cutting tool of claim 1 which is also used as an outside cutting tool of Pipe.
